(19) United States
(12) Patent Application Publication
(10) Pub. No.: US 2014/0218144 A1
(43) Pub. Date: Aug. 7, 2014

(54) Elliptical Unit Block for Preparing Core Using Soft Magnetic Metal Powder and Magnetic Powder Core Prepared Using The Same

(71) Applicant: CHANG SUNG CO., Chungcheongbuk-do (KR)

(72) Inventors: Jae-Yeol Park, Bupyeong-gu (KR); Dal-Joong Kim, Gyeonggi-do (KR); Bong-Gi Yoo, Incheon (KR); Gu-Hyun Kim, Siheung-si (KR); Kwang-Yong Yoo, Yangcheon-gu (KR)

(73) Assignee: CHANG SUNG CO., Chungcheongbuk-do (KR)

(21) Appl. No.: 14/343,063

(22) PCT Filed: Sep. 5, 2012
(86) PCT No.: PCT/KR2012/007095

§ 371 Date: Mar. 6, 2014

(30) Foreign Application Priority Data
Sep. 7, 2011 (KR) 10-2011-0090935

(51) Int. Cl. H01F 3/08; H01F 7/02; H01F 1/22

(52) U.S. Cl. CPC H01F 3/08; H01F 1/22; H01F 7/02
USPC 335/297; 75/228

(57) ABSTRACT

The present invention relates to an elliptical unit block for preparing a core using soft magnetic metal powder and a core with excellent high current DC bias characteristics using the same, and more specifically, to an elliptical unit block for preparing a core using soft magnetic metal powder used in an inductor for an automotive electronic sub-assembly using a high current buck or boost inductor or a three phase line reactor or fuel cell system for power factor correction (PFC), and a powered magnetic core prepared using the same.

### TECHNICAL FIELD

The present disclosure relates to a powdered magnetic core prepared with elliptical unit blocks that may be used in large current applications such as photovoltaic industry, wind power, vehicles, and the like.

The present disclosure relates to an elliptical unit block for preparing a core using soft magnetic metal powder and a core having excellent large current direct current (DC) bias characteristics prepared by using the same, and more particularly, to an elliptical unit block for preparing a core using a soft magnetic metal powder used in a large current buck inductor, a large current boosting inductor, or a three-phase line reactor for power factor correction (PFC), or an inductor used as an electric device of a vehicle using a fuel cell system, and a powdered magnetic core prepared by using the same.

### BACKGROUND ART

A related art soft magnetic core used in a large current bucking inductor, a large current boosting inductor (active filter), or a three-phase line reactor for power factor correction (PFC), or used as an electronic device of a vehicle using a fuel cell system for PFC is prepared as a troidal core, a stacked block core, an EE core, or an EI core with pure iron, a silicon steel plate, amorphous metal, or the like.

The stacked silicon steel plate and the amorphous metal are prepared and stacked in the form of EE and EI through a blanking process, restricting a shape of a core cross-section to a quadrangular shape, and high core loss and magnetostrictive constant thereof generates a large amount of heat and severe noise. In order to solve this problem, a bulk air gap needs to be inserted and a volume needs to be increased, increasing cost.

A soft magnetic toroidal core prepared for the aforementioned purpose has an outer diameter only as large as approximately 100 mm due to a limitation in pressing performance of a high pressure press, so it is ineligible to be used in a product requiring a large size. Thus, a core product prepared in the form of a unit block, overcoming the capacity limitation, has been developed, but since a cross-section of a core has a rectangular shape, a length of a winding part is increased, causing a relatively large copper loss.

A core prepared with pure iron powder is advantageous in terms of cost, but since it has a relatively large amount of core loss, the core is overheated when operated, and when high DC currents are biased, magnetic permeability is drastically lowered.

A molybdenum permalloy powder (MPP) core has good frequency characteristics in a frequency range from 1 kHz to 100 kHz, sustains the least core loss among metal powder cores, and has magnetic permeability reduced to a lesser degree even when high DC currents are biased, but it is costly. A high flux core has good frequency characteristics in a frequency range from 1 kHz to 100 kHz, has low core loss, and magnetic permeability reduced to the smallest degree, among metal powder cores, when high DC currents are biased.

A sendust core exhibits a very low core loss value relative to pure iron, has good frequency characteristics on par with the MPP or high flux core, and costs about half of the MPP or high flux core. However, its DC bias properties in a large current are low relative to the MPP or high flux core. Also, silicon steel powder having a composition including 5 wt % to 8 wt % of silicon (Si) and iron (Fe) comprising the remainder of a total weight of the composition sustains high core loss relative to the MPP, high flux, and sendust cores, but it has DC bias characteristics superior to the MPP or sendust in a large current and incurs low cost.

### DISCLOSURE

### Technical Problem

An aspect of the present disclosure may provide an elliptical unit block for preparing a core using a soft magnetic metal powder, capable of solving a problem of the related art stacked silicon steel plate or amorphous metal having a low degree of freedom in shape, by preventing a core formed thereof from having a shape other than a quadrangular shape, which is capable of reducing copper loss, while assisting high density formation by selectively using MPP, high flux, sendust, or Mega Flux (silicon steel powder) according to a purpose and a size and cost of an inductor, and which is used in a large current reactor for power factor correction (PFC), or an inductor filter for an inverter in photovoltaic or wind power generation, or the like, an inductor for a large DC-DC converter in a photovoltaic and electric vehicle, or in an inductor for an electric vehicle using a fuel cell system, and a powdered magnetic core prepared using the same.

### Technical Solution

According to an aspect of the present disclosure, an elliptical unit block for preparing a core using a soft magnetic metal powder may be formed by selectively molding one or more types of sendust alloy powder, high flux powder or MPP powder, and Mega Flux (silicon steel powder) having a grain size smaller than or equal to 180 μm, in order to form a molded green body with a rectangular shape, and heat-treating the molded green body and subsequently rounding lateral surfaces of corners of the rectangular green body.

The elliptical unit block may be provided as a unit block having a width x within a range of 30 mm≦x≦150 mm, a length y within a range of 10 mm≦y≦100 mm, a height z within a range of 5 mm≦z≦50 mm, and a rounding radius Rc(1) on a lateral surface in the corner within a range of 3 mm≦Rc(1)≦y/2, and as a second unit block having a width A within a range of A≦y, a length B within a range of B≦x/2, a height C within a range of 5 mm≦C≦60 mm, and a rounding radius Rc(2) on a lateral surface in the corner within a range of 3 mm≦Rc(2)≦B/2.

In the unit block, the sendust alloy powder may have a composition comprising 9 wt % to 10 wt % of silicon (Si), 4 wt % to $ wt % of aluminum (Al), and iron (Fe) comprising the remainder of a total weight of the composition, the MPP powder may have a composition comprising 80 wt % to 81 wt % of nickel (Ni), 16 wt % to 18 wt % of iron (Fe), and 1.5 wt % to 2.5 wt % of molybdenum, and the silicon steel powder may have a composition comprising 5 wt % to 8 wt % of silicon (Si) and iron (Fe) comprising the remainder of a total weight of the composition, and a powdered magnetic core prepared by bonding the elliptical unit blocks with a heat-resistant and fire-resistant epoxy or polyurethane adhesive may also be provided.

### Advantageous Effects

According to exemplary embodiments of the present disclosure, both surfaces of unit blocks according to exemplary embodiments of the present disclosure are rounded to significantly reduce a winding length relative to an existing rectangular block type core and have high efficiency relative to the existing block type core, while maintaining the same mean magnetic path length as that of the existing block type core.

Also, high DC bias characteristics may be obtained by increasing molding pressure through rounding. Also, since the elliptical unit block has a smaller circumferential length and higher density, it may obtain high DC bias characteristics and thus enhance efficiency while maintaining an effective sectional area equal to that of the existing rectangular block type core.

Since an elliptical unit block core according to an exemplary embodiment of the present disclosure exhibit excellent DC bias characteristics, low core loss characteristics, and low-noise characteristics due to high density over a large current, heat and noise may be reduced, and since noise is reduced, inductor characteristics may be enhanced.

The elliptical unit block core according to an exemplary embodiment of the present disclosure may replace a soft magnetic core having a conventional shape without a degree of freedom or a core having a rectangular sectional area, and may be widely utilized with various sizes and shapes.

In addition, the core according to an exemplary embodiment of the present disclosure may have improved shape and characteristics remarkably reducing copper loss (loss made by 12R due to a current flowing in a winding part due to Joule's heat) and exhibit high DC bias characteristics relative to the existing rectangular block type core, and since the overall length of winding is significantly reduced, overall system efficiency may be enhanced and power density may be increased.

### DESCRIPTION OF DRAWINGS

FIG. 1 is a view illustrating an example of a first elliptical unit block using a soft magnetic metal powder according to an exemplary embodiment of the present disclosure;

FIG. 2 is a view illustrating another example of a second elliptical unit block using a soft magnetic metal powder according to an exemplary embodiment of the present disclosure;

FIG. 3 is a perspective view of a magnetic core prepared using an elliptical unit block according to an exemplary embodiment of the present disclosure; and

FIG. 4 is a table showing a comparison between copper loss of an elliptical unit block according to an exemplary embodiment of the present disclosure and copper loss of an existing rectangular unit block.

### BEST MODE

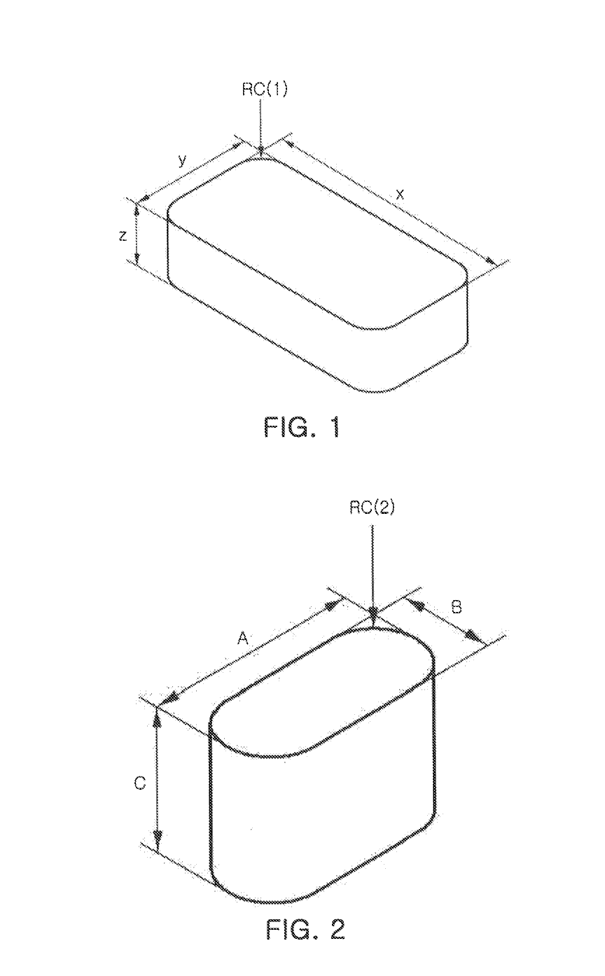

The present disclosure relates to an elliptical unit block for preparing a core using a soft magnetic metal powder. The elliptical unit block is formed by selectively molding one or more types of sendust alloy powder, high flux powder or MPP powder, and Mega Flux (silicon steel powder) having a grain size smaller than or equal to 180 μm, and subsequently heat-treating the same. The elliptical unit block has sizes and shapes as illustrated in FIGS. 1 and 2.

Also, the present disclosure relates to an elliptical unit block for preparing a core using a soft magnetic metal powder, in which the sendust alloy powder has a composition comprising 9 wt % to 10 wt % of silicon (Si), 4 wt % to 8 wt % of aluminum (Al), and iron (Fe) comprising the remainder of a total weight of the composition. The high flux powder has a composition comprising 45 wt % to 55 wt % of nickel (Ni) and iron (Fe) comprising the remainder of a total weight of the composition. The MPP powder has a composition comprising 80 wt % to 81 wt % of nickel (Ni), 16 wt % to 16 wt % of iron (Fe), and 1.5 wt % to 2.5 wt % of molybdenum. The Mega Flux (silicon steel powder) has a composition comprising 3 wt % to 8 wt % of silicon (Si) and iron (Fe) comprising the remainder of a total weight of the composition.

A core according to an exemplary embodiment of the present disclosure is prepared by bonding an elliptical unit block for preparing a core prepared by selecting one or more types of sandust alloy powder, high flux powder or MPP powder, and Mega Flux (silicon steel powder) by using a heat-resistant and fire-resistant epoxy or a polyurethane adhesive into a single-phase reactor and a 3-phase reactor. Since the core utilizes the elliptical unit block for preparing a core using soft magnetic metal powder, it has excellent high current DC bias characteristics.

Also, a preparation method according to an exemplary embodiment of the present disclosure includes selecting one or more types of sandust alloy powder, high flux powder or MPP powder, and Mega Flux (silicon steel powder) having a grain size smaller than or equal to 180 μm, adding a solid lubricant thereto, and mixing the powder and the solid lubricant; molding the mixture powder with pressure ranging from 10 tons to 20 tons per unit area such that elliptical unit blocks finally prepared with the mixture powder have a size of 3 cm to 10 cm in width, 1 cm to 5 cm in length, and 1 cm to 5 cm in height; heat-treating the molded green bodies at a temperature ranging from 600° C. to 800° C. for one to two hours under an inert atmosphere to prepare elliptical unit blocks having 3 cm to 15 cm in width, 1 cm to 10 cm in length, and 1 cm to 5 cm in height, and bonding the prepared elliptical unit blocks into a core form by using a heat-resistant and fire-resistant epoxy or polyurethane adhesive to thus prepare a core.

Hereinafter, the configuration of an exemplary embodiment of the present disclosure will be described in detail with reference to the accompanying drawings.

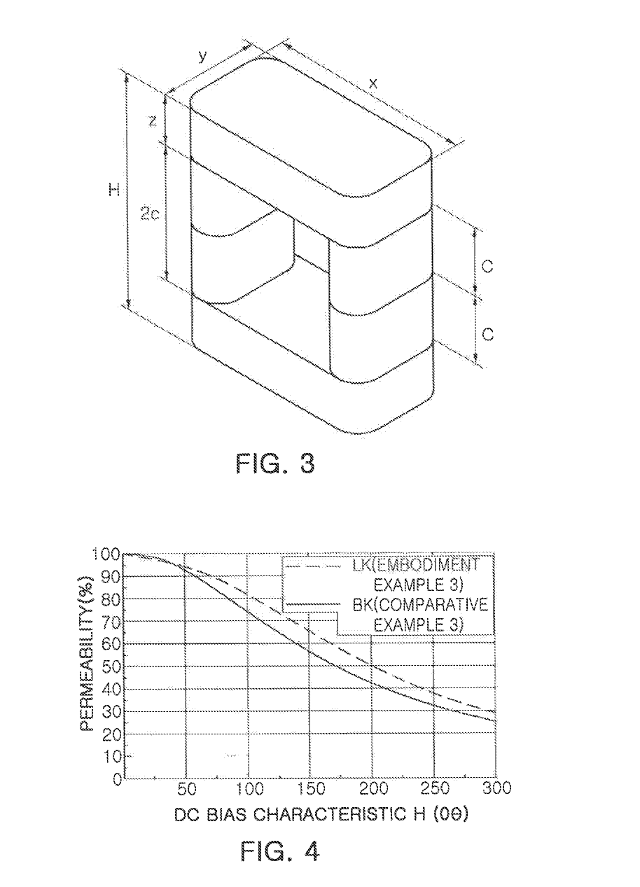

FIGS. 1 and 2 are views illustrating elliptical unit blocks using a soft magnetic metal powder according to an exemplary embodiment of the present disclosure, and FIG. 3 is a perspective view of a single-phase core prepared using an elliptical unit block for preparing a core using soft magnetic metal powder according to an exemplary embodiment of the present disclosure.

FIGS. 1 and 2 illustrate elliptical unit blocks with lateral surfaces rounded at the corners.

A first unit block in FIG. 1 may form upper and lower plates of a core among elliptical unit blocks. The first block in FIG. 1, an elliptical unit block, may be formed to have a width x within a range of 30 mm≦x≦150 mm, a length y within a range of 10 mm≦y≦100 mm, a height z within a range of 5 mm≦z≦50 mm, and a rounding radius Rc(1) on a lateral surface in the corner within a range of 3 mm≦Rc(1)≦y/2.

Here, if the rounding radius Rc(1) is smaller than 3 mm, a rounding effect may not be anticipated, and the rounding radius Rc(1) may not exceed y/2.

Also, a second unit block in FIG. 2 may form a column of the core among the elliptical unit blocks. The second unit block of FIG. 2 is an elliptical unit block having a width A within a range of A≦y, a length B within a range of B≦x/2, a height C within a range of 5 mm≦C≦160 mm, and a rounding radius Rc(2) on a lateral surface in the corner within a range of 3 mm≦Rc(2)≦B/2.

Here, if the rounding radius Rc(2) is smaller than 3 mm, a rounding effect may not be anticipated, and the rounding radius Rc(2) may not exceed B/2.

The reason for limiting the dimensions of width x, length y, and height z is because, in relation to lower limits, if the dimensions of the first unit block are 30 mm in width x, 10 mm in length y, and smaller than 5 mm in height z, a great amount of time is required and large expense is incurred in assembling the unit blocks, and in relation to upper limits, if the dimensions of the first unit block exceed 150 mm in width x, 100 mm in length y, and 50 mm in height z, it is practically impossible to install a press required for preparing the unit blocks. The second unit block is dependent upon the first unit block, so numerical values thereof are limited for the same reasons as mentioned above.

Also, a maximum grain size of the soft magnetic metal powder used in an exemplary embodiment of the present disclosure is limited to be smaller than or equal to 180 μm, and this is to secure forming strength of the unit blocks and prevent damage of a press.

Also, in an exemplary embodiment of the present disclosure, the unit blocks are formed with pressure ranging from 10 tons to 20 tons per cm². With pressure less than 10 tons, it is difficult to maintain the form of the unit blocks, and with pressure greater than 20 tons, there is a limitation in facility.

Meanwhile, the unit block green bodies prepared under the foregoing conditions are heat treated for one to two hours at a temperature ranging from 600° C. to 800° C. under an inert atmosphere to form elliptical unit blocks, and here, the temperature and the holding time are limited in order to remove residual stress remaining in the elliptical unit blocks when molded while maintaining a non-oxidizing atmosphere.

Also, the elliptical unit blocks prepared as described above are bonded into a core form by using a heat-resistant and fire-resistant adhesive; in this case, an epoxy or polyurethane adhesive is used as the heat-resistant and fire resistant adhesive.

The reason for using the heat-resistant and fire-resistant epoxy or polyurethane adhesive is that it has properties of retaining adhesive strength even at a high temperature higher than or equal to 100° C. at which the core is actually used.

Hereinafter, a process for preparing soft magnetic metal powder used in an exemplary embodiment of the present disclosure will be described.

In an exemplary embodiment, sendust alloy powder used in an exemplary embodiment of the present disclosure was prepared in the same manner as that of Korean Patent Application No. 1998-62927 by the same applicant of this disclosure, and it may be described briefly as follows.

First, sendust ingot or shot having a composition comprising 9.6 wt % of silicon (Si), 5.4 wt % of aluminum (Al), and iron (Fe) comprising the remainder of a total weight of the composition, and having high magnetic permeability and low loss characteristics, was crushed with a jaw crusher, rotary crusher, hammer mill, or the like, subjected to ball milling for 1 to 3 hours, and heat-treated for 8 hours under a mixture gas atmosphere of hydrogen and nitrogen at a temperature ranging from 800° C. to 900° C., and thereafter, 1.0 wt % to 2.5 wt % of insulating ceramic was wet-insulation-coated or dry-insulation-coated with a ceramic binder having a low melting point in order to obtain sandust powder.

Also, high flux and MPP powder comprising nickel (Ni) and iron (Fe) or nickel (Ni) and iron (Fe) and molybdenum (Mo) was prepared in the same manner as that disclosed in Patent Application Nos. 2001-61455 and 1997-9412 by the applicant of this disclosure, and the preparation method thereof is as follows.

High flux or MPP powder was prepared through a spray method and heat-treated at a temperature ranging from 800° C. to 900° C. under a mixture gas atmosphere of hydrogen and nitrogen, and 0.5 wt % to 3.0 wt % of mixture ceramic was applied thereto to perform insulating coating. The mixture ceramic was obtained by mixing magnesium hydroxide, kaolin, talc, and sodium silicate.

Thereafter, as for Mega Flux (silicon steel powder) having excellent DC bias characteristics, as disclosed in Korean Patent Application No. 2000-4180 of the same application of this disclosure, iron (Fe) and silicon (Si) were melted to obtain a composition comprising 6.5 wt % of silicon (Si) and (Fe) comprising the remainder of a total weight of the composition, and one of nitrogen gas (N2), helium (He), neon (Ne), argon (Ar), xenon (Xe), and radon (Rn) or a mixture gas obtained by mixing two or more of the above was jetted thereto in order to obtain powder. The powder was heat-treated at a temperature ranging from 800° C. to 900° C. for 8 hours under a hydrogen or nitrogen gas atmosphere or under a mixture gas atmosphere of hydrogen and nitrogen. Thereafter, powder having a grain size equal to −80 mesh (smaller than or equal to 180 μm) was selectively prepared and wet-insulation-coated by using 0.5 wt % to 20 wt % of mixture ceramic or dry-insulation-coated with glass frits to obtain Mega Flux (silicon steel powder) for block preparation.

Also, composite powder may be prepared by using a technique disclosed in Korean Patent Application No, 2000-46247 of the same application of this disclosure according to use purpose.

Subsequently, an appropriate amount of solid lubricant such as zinc (Zn), zinc sulfide (ZnS), or stearate was added to the prepared powder (Mpp, high flux, sendust composite powder), and mixed to mold a block type core.

Molding was performed in a molding die by using a power press, and the lubricant was used to reduce frictional force between the molding die and the closely packed green bodies and friction between powder particles.

Here, molding pressure ranging from 100 tons to 500 tons (10 tons to 20 tons per cm²) was applied to mold the elliptical unit blocks having dimensions of 600 cm in width, 3.5 cm in length, and 2.5 cm in height.

Subsequently, in order to remove residual stress and strain, the molded elliptical unit blocks were heat-treated at a temperature ranging from 600° C. to 800° C. for 1 hour under a nitrogen atmosphere to complete elliptical unit blocks for core preparation.

A size and a shape of the elliptical unit blocks completed through the foregoing process were designed according to capacity and applications of a core, and the resultant elliptical unit blocks were assembled by using an adhesive having excellent heat resistance and fire resistance and installed outside of a bracket, thus completing a core facilitating surface mounting and tolerating vibration and impact.

As shown in Table 1, Embodiment Example 1 is an elliptical unit block prepared by molding Mega Flux (silicon steel powder) with pressure equal to 16 ton/cm², and Comparative Example 1 is a rectangular unit block prepared by using the same powder as described above through the same preparation method.

Namely, the elliptical unit block has a length per turn 3.2% shorter than that of the existing rectangular block in winding, while obtaining an effective sectional area 6% greater than that of the existing rectangular unit block. Thus, a wire length of the elliptical unit block according to the Embodiment Example may be designed to be shorter, while maintaining high DC bias characteristics.

TABLE 1

| | Embodiment Example | Comparative Example |
|---|---|---|
| | 1 (35 × 15) | 1 (30 × 15) |
| Shape | 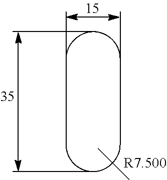 | 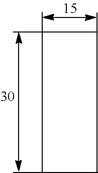 |
| Length per | 87.12 | 90 |
| turn [mm] | | |
| Sectional | 4.77 | 4.50 |
| area [mm²] | | |

As shown in Table 2, the elliptical unit block (Embodiment Example 2) has a length per turn 2.9% shorter than that of the existing rectangular block (Comparative Example 2) in winding, while obtaining an effective sectional area 8.7% greater than that of the existing rectangular unit block. Thus, a wire length of the elliptical unit block according to the Embodiment Example may be designed to be shorter, while maintaining high DC bias characteristics.

TABLE 2

| | Embodiment Example | Comparative Example |
|---|---|---|
| | 2 (33 × 15) | 2 (30 × 15) |
| Shape | 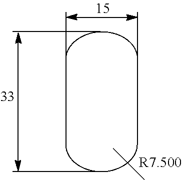 | 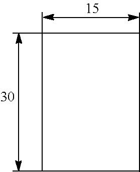 |
| Length per | 83.1 | 90 |
| turn [mm] | | |
| Sectional | 450 | 450 |
| area [mm²] | | |

Table 3 shows a comparison between DC bias characteristics of powdered magnetic core (a combination of two first unit blocks and six second unit blocks) using elliptical unit blocks according to Embodiment Example 3 and those of a power magnetic core using existing rectangular unit blocks according to Comparative Example 3.

TABLE 3

| | 60 μDCB % | | |
|---|---|---|---|
| Block form | @100 Oe | @150 Oe | @200 Oe |
| Embodiment | 82% | 66% | 50% |
| Example 3 | | | |
| Comparative | 74% | 56% | 42% |
| Example 3 | | | |

Also, FIG. 4 is a graph illustrating the results of Table 3, in which it can be seen that the elliptical unit blocks according to Embodiment Example 3 have DC characteristics superior to those of the existing rectangular unit blocks according to the Comparative Example 3.

Table 4 shows a comparison between direct current resistance (DCR) of powdered magnetic core (a combination of two first unit blocks and six second unit blocks) using elliptical unit blocks according to Embodiment Example 3 and those of a power magnetic core using existing rectangular unit blocks according to Comparative Example 3.

As shown in Table 4, it can be seen that the powdered magnetic core using the elliptical unit blocks has DCR 17% lower than that of the powdered magnetic core using the existing rectangular unit blocks.

TABLE 4

| Block form | DCR (mΩ) | Remark |
|---|---|---|
| Embodiment example | 16.86 | 30 turns + 50 |
| 3 | | turns |
| Comparative | 20.37 | 50 turns + 50 |
| example 3 | | turns |

### INDUSTRIAL APPLICABILITY

The elliptical unit blocks for preparing a core using soft metal powder, which solves the problem of the related art stacked silicon steel plate or amorphous metal with which a sectional area of a core may not escape from a rectangular shape, having a low degree of freedom, which allows for high density molding by selectively using MPP, high flux, sendust, and Mega Flux (silicon steel powder) according to purpose and a size and cost of an inductor, and reduces copper loss, and which may be used in a large current reactor for power factor correction (PFC), an inductor filter for an inverter in photovoltaic or wind power generation, an inductor for a large capacity DC-DC converter of a photovoltaic and electric vehicle, or an inductor as an electrical device of an electric vehicle using a fuel cell system, and a powdered magnetic core prepared using the same may be provided.

1. An elliptical unit block for preparing a core using soft magnetic metal powder, formed by selectively molding one or more types of sendust alloy powder, high flux powder or MPP powder, and Mega Flux (silicon steel powder) having a grain size smaller than or equal to 180 μm, in order to form a molded green body with a rectangular shape, and heat-treating the molded green body and subsequently rounding lateral surfaces of corners of the rectangular green body.

2. The elliptical unit block of claim 1, wherein the elliptical unit block is a unit block having a width x within a range of 30 mm≦x≦150 mm, a length y within a range of 10 mm≦y≦100 mm, a height z within a range of 5 mm≦z≦50 mm, and a rounding radius Rc(1) on a lateral surface in the corner within a range of 3 mm≦Rc(1)≦y/2.

3. The elliptical unit block of claim 1, wherein the elliptical unit block is a second unit block having a width A within a range of A≦y, a length B within a range of B≦x/2, a height C within a range of 5 mm≦C≦60 mm, and a rounding radius Rc(2) on a lateral surface in the corner within a range of 3 mm≦Rc(2)≦B/2.

4. The elliptical unit block of claim 1, wherein the sandust alloy powder has a composition comprising 9 wt % to 10 wt % of silicon (Si), 4 wt % to 8 wt % of aluminum (Al), and iron (Fe) comprising the remainder of a total weight of the composition, the MPP powder has a composition comprising 80 wt % to 81 wt % of nickel (Ni), 16 wt % to 18 wt % of iron (Fe), and 1.5 wt % to 2.5 wt % of molybdenum, and
the silicon steel powder has a composition comprising 5 wt % to 8 wt % of silicon (Si) and iron (Fe) comprising the remainder of a total weight of the composition.

5. A powdered magnetic core, prepared by bonding the elliptical unit blocks according to claim 1 with a heat-resistant and fire-resistant epoxy or polyurethane adhesive.

6. A powdered magnetic core, prepared by bonding the elliptical unit blocks according to claim 2 with a heat-resistant and fire-resistant epoxy or polyurethane adhesive.

7. A powdered magnetic core, prepared by bonding the elliptical unit blocks according to claim 3 with a heat-resistant and fire-resistant epoxy or polyurethane adhesive.

8. A powdered magnetic core, prepared by bonding the elliptical unit blocks according to claim 4 with a heat-resistant and fire-resistant epoxy or polyurethane adhesive.
